(19) United States
(12) Patent Application Publication
(10) Pub. No.: US 2015/0244823 A1
(43) Pub. Date: Aug. 27, 2015

(54) APPARATUS AND METHOD FOR PROVIDING PUSH SERVICE BASED ON LOCATION

(71) Applicant: Samsung Electronics Co., Ltd., Gyeonggi-do (KR)

(72) Inventors: Ki-Young Lim, Gyeonggi-do (KR); Jae-Hyun Park, Gyeonggi-do (KR); Hey-Young Park, Seoul (KR); Ki-Won Lee, Gyeonggi-do (KR); Woo-Hyuk Jang, Gyeonggi-do (KR); Han-Seong Jung, Seoul (KR); Jong-Kyu Bae, Incheon (KR)

(21) Appl. No.: 14/466,071

(22) Filed: Aug. 22, 2014

(30) Foreign Application Priority Data
Feb. 21, 2014 (KR) 10-2014-0020835

(51) Int. Cl. H04L 29/08

(52) U.S. Cl. CPC H04L 67/26; H04L 67/18

(57) ABSTRACT

An apparatus and method for efficiently controlling transmission of a large amount of push messages based on a location in a system of providing a location-based push service is disclosed. A push server is configured to search for at least one target electronic device to which a push message is to be transmitted, from among a plurality of electronic devices maintaining sessions with the push server, with reference to a table that stores location information of the plurality of electronic devices. The push server is also configured to transmit the push message to the found at least one target electronic device. Accordingly, since operation of searching for at least one target electronic device satisfying a location condition from among a plurality of electronic devices maintaining sessions with a push server is distributively processed by at least one push server, push messages is quickly transmitted.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Feb. 21, 2014 and assigned Serial No. 10-2014-0020835, the entire disclosure of which both of which is incorporated herein by reference.

### TECHNICAL FIELD

The present disclosure relates generally to an apparatus and method for providing data to an electronic device.

### BACKGROUND

With popularization of electronic devices, such as a smart phone and a tablet computer, a push service is used for various purposes. To keep pace with this, various kinds of applications supporting a push service are being developed. The push service is aiming at sending a specific message or notification to electronic devices. The push service sends a message or notification to each application being executed in an electronic device on the mobile platform while maintaining public network connectivity.

### SUMMARY

To address the above-discussed deficiencies, it is a primary object to provide a method and apparatus for efficiently sending push messages in real time to a plurality of electronic devices located in a predetermined region.

In a first example, a method and apparatus for efficiently managing location information of a plurality of electronic devices in order to raise the operating efficiency of a location-based push service is provided.

In a second example, a method and apparatus for quickly sending push messages by minimizing a time taken to search for a plurality of target electronic devices when providing a location-based push service is provided.

In a third example, a method of providing a location-based push service in a push server includes searching for at least one target electronic device to which a push message is to be transmitted, from among a plurality of electronic devices maintaining sessions with the push server, with reference to a table that stores location information of the plurality of electronic devices. The method also includes transmitting the push message to the found at least one target electronic device.

In a fourth example, a push server for providing a location-based push service includes a memory configured to store a table in which location information of a plurality of electronic devices maintaining sessions with the push server is mapped to the corresponding electronic devices. The server also includes a target determiner configured to search for at least one target electronic device to which a push message is to be transmitted, from among the plurality of electronic devices, with reference to the table, and to control the push server to transmit the push message to the found at least one target electronic device.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is an example of a system that supports a location-based push service according to this disclosure;

FIG. 2 is an example block diagram illustrating a configuration of an electronic device according to this disclosure;

FIG. 3 is an example of a system that provides a location-based push service according to this disclosure;

FIG. 4 is an example block diagram illustrating a configuration of a push server according to this disclosure;

FIG. 5 is an example flowchart illustrating a method of controlling transmission of push messages according to this disclosure; and

FIG. 6 is an example block diagram illustrating a configuration of hardware according to this disclosure.

Throughout the drawings, like reference numerals will be understood to refer to like parts, components, and structures.

### DETAILED DESCRIPTION

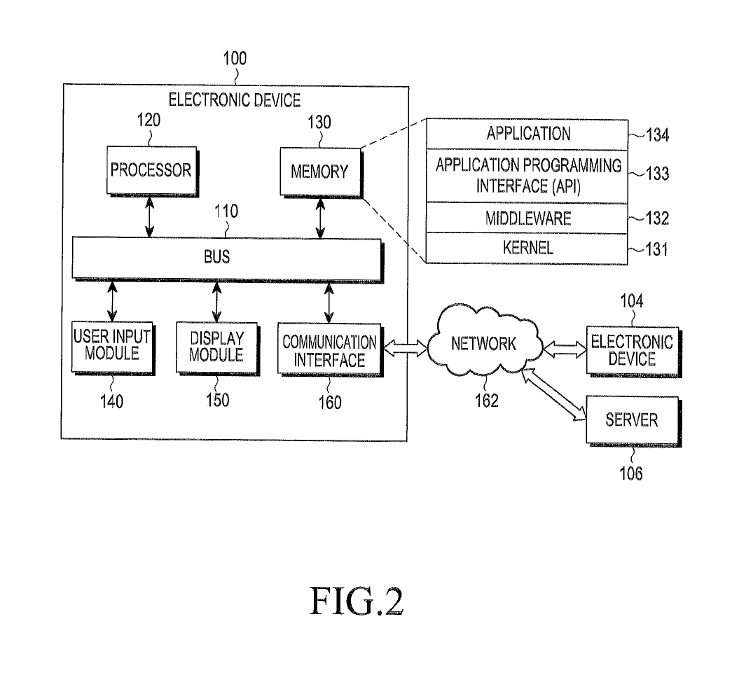

FIGS. 2 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Hereinafter, the present disclosure will be described with reference to the appended drawings. However, specific structural and functional details disclosed herein are merely representative for purposes of describing example embodiments of the present disclosure, however, example embodiments of the present disclosure can be embodied in many alternate forms and should not be construed as limited to example embodiments of the present disclosure set forth herein.

Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure. Like numbers refer to like elements throughout the description of the figures.

It will be understood that the terms “comprises”, “can comprise,”, “includes” and/or “can include”, when used herein, specify the presence of stated functions, operations, and/or components, but do not preclude the presence or addition of one or more other functions, steps, and/or components. It will be further understood that the terms “comprises” or “has”, when used herein, specify the presence of stated features, integers, steps, operations, elements, components and/or groups thereof, but do not preclude the presence or addition of one or more other features, integers, steps, operations, elements, components, and/or groups thereof.

As used herein, the term “and/or” includes any and all combinations of one or more of the associated listed items. For example, “A and/or B” can include A, B, or both A and B.

It will be understood that, although the terms first, second, etc. can be used herein to describe various components, these components should not be limited by these terms. For example, the terms do not limit the order and/or importance of the components. These terms are only used to distinguish one component from another. For example, a first user device and a second user device that are user devices indicate different user devices. For example, a first component could be termed a second component, and, similarly, a second component could be termed a first component, without departing from the scope of the present disclosure.

It will be understood that when a component is referred to as being “connected” or “coupled” to another component, it can be directly connected or coupled to the other component or intervening components can be present. In contrast, when a component is referred to as being “directly connected” or “directly coupled” to another component, there are no intervening components present. The terminology used herein is for the purpose of describing particular embodiments only and is not intended to be limiting of the disclosure. As used herein, the singular forms “a”, “an” and “the” are intended to include the plural forms as well, unless the context clearly indicates otherwise.

Examples of a push service can include a location-based marketing service, a location-based notification service, and a location-based broadcast service, and particularly, the location-based broadcast service is widely used for various purposes.

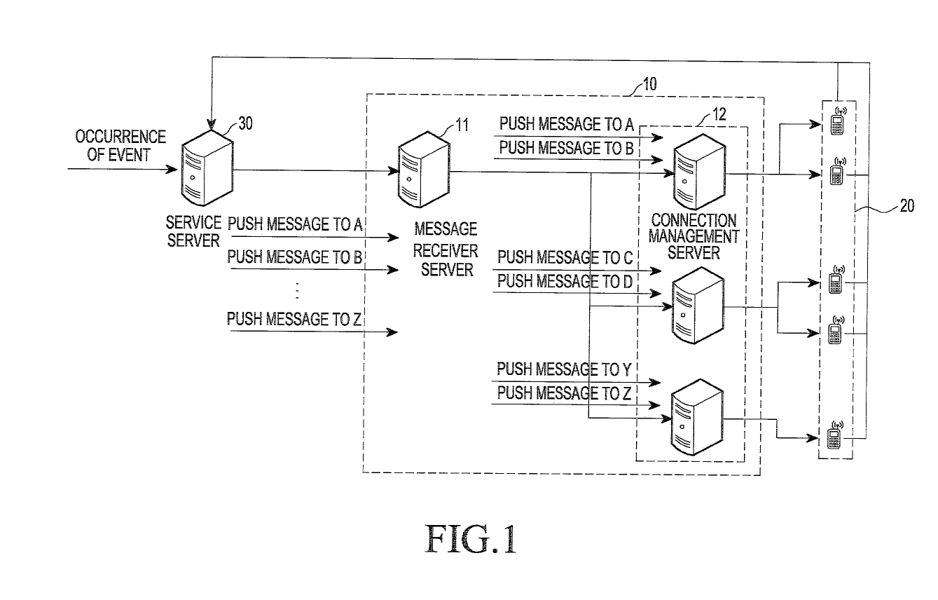

FIG. 1 is an example of a system that supports a location-based push service according to this disclosure. Referring to FIG. 1, the system can include a push server 10, a plurality of electronic devices 20, and a service server 30. The service server 30 can correspond to an application that supports a push service operating on an electronic device. The push server 10 that supports a location-based push service can receive a push message from the service server 30, and can transmit the push message to the electronic devices 20 located within a predetermined range.

In order to provide a location-based push service, the individual electronic devices 20 can upload their location information to the service server 30, and the service server 30 can store and manage the location information of the individual electronic devices 20. Since an electronic device installs, generally, a plurality of applications supporting a push service, there can also be a plurality of service servers 30. Accordingly, each service server 30 can store and manage location information of the individual electronic devices 20.

In order for the service server 30 to send push messages to electronic devices located in a specific region, the service server 30 may search for target electronic devices to which it will in a specific region, the service server 30 can search for target electronic devices to which it will send push messages, based on location information of the individual electronic devices 20. However, since the amount of location information of the electronic devices 20 that are managed by the service server 30 can be huge, it can take a long time to search for the electronic devices 20 located in the specific region. Also, the service server 30 can generate a plurality of push messages based on the found electronic devices 20, and can request the push server 10 to send the plurality of push messages to the electronic devices 20.

For example, if target electronic devices to which push messages will be sent are A to X, the service server 30 can send push messages corresponding to the number of the target electronic devices A to X to a message receiver server 11 of the push server 10. Then, the message receiver server 11 can send the push messages to the electronic devices A to X, respectively, through connection management servers 12. In this case, since the push server 10 receives a large amount of push messages at the same time from the service server 30, traffic can be aggregated onto the push server 10.

An electronic device according to various embodiments of the present disclosure can be a device with communication capabilities. For example, the electronic device can be one or a combination of two or more of various devices such as smart phone, tablet Personal Computer (PC), mobile phone, video phone, e-Book reader, desktop PC, laptop PC, Netbook computer, Personal Digital Assistant (PDA), Portable Multimedia Player (PMP), MP3 player, mobile medical equipment, wearable device (for example, a Head-Mounted-Device (HMD), electronic clothes, electronic clock, wrist watch, electronic bracelet, electronic necklace, electronic Appcessory, or smart watch), home appliance (for example, refrigerator, air conditioner, cleaner, oven, microwave, washer, air purifier and the like), Artificial Intelligence (AI) robot, Television (TV), Digital Versatile Disk (DVD) player, audio equipment, various medical devices (for example, Magnetic Resonance Angiography (MRA), Magnetic Resonance Imaging (MRI), Computed Tomography (CT), medical camcorder, ultrasonic equipment, and the like), navigation device, Global Positioning System (GPS) receiver, Event Data Recorder (EDR), Flight Data Recorder (FDR), set-top box, TV box (for example, Samsung HomeSync™, Apple TV™, Google TV™, or the like), electronic dictionary, automotive infotainment device, electronic equipment for ship (for example, marine navigation device, gyro compass, and the like), avionics, security equipment, electronic apparel, electronic key, camcorder, game consoles, flat panel display device, electronic picture frame, electronic album, furniture or part of building/structure with communication capabilities, electronic board, electronic signature receiving device, projector, and the like. It will be apparent to those of ordinary skill in the art that the electronic device according to various exemplary embodiments of the present disclosure is not limited to the aforementioned devices.

FIG. 2 is an example block diagram illustrating a configuration of an electronic device according to this disclosure. Referring to FIG. 2, an electronic device 100 can include a bus 110, a processor 120, a memory 130, a user input module 140, a display module 150, and a communication module 160.

The bus 110 can be a circuit that connects the aforementioned components to each other and that enables communications (for example, transmission of control messages) between the components.

The processor 120 can receive, for example, an instruction from the components (for example, the memory 130, the user input module 140, the display module 150, or the communication module 160) through the bus 110, interpret the received instruction, and perform operation or data processing according to the interpreted instruction.

The memory 130 can store instructions or data received from or generated by the processor 120 or the other component (for example, the user input module 140, the display module 150, or the communication module 160). The memory 130 can include programming modules, for example, such as a kernel 131, middleware 132, an Application Programming Interface (API) 133, an application 134 and the like. Each of the programming modules can be software, firmware, hardware, or a combination of two or more of the aforementioned devices.

The kernel 131 can control or manage system resources (for example, the bus 110, the processor 120, or the memory 130) which the other programming modules (for example, the middleware 132, the API 133, or the application 134) use to execute their operations or functions. Also, the kernel 131 can provide an interface enabling the middleware 132, the API 133, or the application 134 to access individual components of the electronic device 100 and to control or manage the components.

The middleware 132 can act as an intermediary so that the API 133 or the application 134 can communicate with the kernel 131 to receive/transmit data from/to the kernel 131. Also, the middleware 132 can perform, when operation requests are received from the application 134 (or a plurality of applications 134), load balancing for the operation requests, for example, by allocating priority capable of using a system resource (for example, the bus 110, the processor 120, or the memory 130) of the electronic device 100 to the application 134 (at least one of the plurality of applications 134).

The API 133 can be an interface that enables the application 134 to control functions that are provided by the kernel 131 or the middleware 132. The API 133 can include at least one interface or function, for example, for file control, window control, image processing, character control, and the like.

The user input module 140 can receive an instruction or data, for example, from a user, and can transfer the received instruction or data to the processor 120 or the memory 130 through the bus 110. The display module 150 can display images, video, or data for a user.

The communication module 160 can enable the electronic device 100 to communicate with another electronic device 104 or a server 106. The communication module 160 can support a predetermined short-range communication protocol (for example, wireless fidelity (WiFi), Bluetooth (BT), Near Field Communication (NFC) or the like), or a predetermined network communication (for example, Internet, Local Area Network (LAN), Wire Area Network (WAN), telecommunication network, cellular network, satellite network, Plain Old Telephone Service (POTS) or the like) 162. The electronic device 104 can be a device that is identical to or different from the electronic device 100. For example, the electronic device 104 can be the same kind of device as the electronic device 100 or a different type of device from the electronic device 100.

Hereinafter, a method and apparatus for efficiently controlling transmission of a large amount of push messages based on a location in a system of providing a location-based push service, according to various embodiments of the present disclosure, will be described. In an embodiment, a push server can search for at least one target electronic device to which a push message is to be transmitted, with reference to a table that stores location information of a plurality of electronic devices maintaining sessions with the push server, and can transmit the push message to the found at least one target electronic device. Since operation of searching for at least one target electronic device satisfying a location condition from among a plurality of electronic devices maintaining sessions with a push server can be distributively processed by at least one push server, push messages can be quickly transmitted.

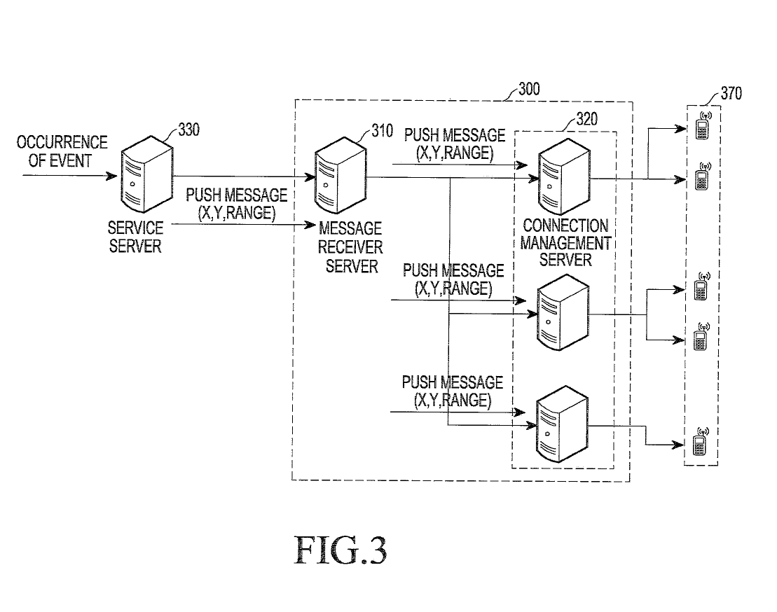

FIG. 3 is an example of a system that provides a location-based push service according to this disclosure.

Referring to FIG. 3, a system that provides a location-based push service can include a service server 330, a push server 300, and a plurality of electronic devices 370. There can be provided a plurality of push servers 300 that transmit push messages. In FIG. 3, a plurality of push servers can be supposed through a plurality of connection management servers 320.

The service server 330 can function to generate a push message that is broadcasted. The service server 330 can provide an application that supports a push service, such as a Social Networking Service (SNS), a marketing service, or a game service, among applications operating on the electronic devices 370. For example, the service server 330 can provide, as an example of a push service that is provided by a marketing company, a discount coupon, or a notification message such as guide information, to all electronic devices located in a predetermined range from a specific store. In FIG. 3, one service server 330 is shown, however, there can be provided a plurality of service servers to respectively correspond to a plurality of applications supporting a push service.

The service server 330 can be any service server that can provide emergency information. An example of a push service can be a message provided by a Cell Broadcast message Service (CBS) server or an Earthquake and Tsunami Warning Service (ETWS) server that provides emergency and disaster information when a disastrous situation (for example, typhoon, tsunami, earthquake or the like) of emergency has occurred in a specific region. However, the push server is not limited to the CBS server or ETWS server.

The service server 330 can generate a push message including information designating a location to which the push message is to be broadcasted. For example, when the service server 330 intends to broadcast a shopping notification push message to electronic devices located in a specific shopping mall, the service server 330 can generate a push message designating a location of the shopping mall and an effective range to which the push message is transferred from the location of the shopping mall. Accordingly, the service server 330 can transfer a push message including coordinates and a range (x, y, range) of a target location to which a push message is to be broadcasted to the push server 300. Since the service server 330 can send a push message designating a target location to which the push message is to be broadcasted, a service provider can send a specialized push message to a desired location.

For example, a service server that provides a SNS, can send a large amount of push messages at the same time to all electronic devices. However, it is possible to send push messages to target electronic devices located in a desired region, which leads to better use of push messages and linkage with various other services. Furthermore, since there is only a need to send a push message, that is, a push service request from the service server 330 to the push server 300, without having to consider a maximum bit rate per second (Quota) allocated to the push service in order to transmit a large amount of push messages, it is possible to efficiently send a large amount of push messages without exceeding an available transmission amount allocated to each service.

The electronic device 370 can include a module that can connect to the wireless Internet. In order for the electronic device 370 to access the push server 300 and receive a push message from the push server 300, the electronic device 370 can register itself in the push server 300. During the registration, the electronic device 370 can be authenticated, and if the authentication is successful, the electronic device 370 can access the push server 300, and can receive a push message from the push server 300.

The electronic device 370 can provide its location information to the push server 300 at a time when it connects to the push server 300. The electronic device 370 can transmit a connection request to the push server 300 when the electronic device 370 initially connects to the push server 300 in order to use a push service, when the electronic device 370 registers itself in the push server 300, when the electronic device 370 again enters a service area of the push server 300 after deviating out of the service area of the push server 300, or when the electronic device 370 again connects to the push server 300 after temporary disconnection from the push server. Together with the connection request, the electronic device 370 can transmit its location information to the push server 300.

The push server 300 can include a message receiver server 310 and a connection management server 320. The message receiver server 310 and the connection management server 320 which are components constituting the push server 300 can be implemented as devices or modules.

The message receiver server 310 can receive a broadcast push message from the service server 330, and can transfer the broadcast push message to the connection management server 320.

The connection management server 320 can store, if receiving location information from the electronic device 370, the location information together with connection information about the electronic device 370. The location information of the electronic device 370 can be information about the location of the electronic device 370 at a time when the electronic device 370 connects to the push server 300, and can include at least one among, for example, a token of the electronic device 370, information about a session connection with the push server 300, network identification information, and location coordinates.

The connection management server 320 can temporarily store the location information of the electronic device 370, provided when the electronic device 370 has connected to the push server 300, while a session with the electronic device 370 is maintained. The connection management server 320 can map location information of electronic devices to the corresponding electronic devices, respectively, to manage the results of the mapping in the form of a table. However, since the number of the electronic devices 370 that connect to the connection management server 320 is very large, it can be difficult to continuously manage location information of such a large number of the electronic devices 370, because of capacity limitation. Accordingly, when a session with at least one of the electronic devices 370 maintaining sessions with the push server 300 is disconnected, the connection management server 320 can delete location information of the disconnected electronic device from the table.

Accordingly, if the connection management server 320 receives information about a target location to which a push message is to be broadcasted, for example, a push message including a target location and a target range (X, Y, range) through the message receiver server 310, the connection management server 320 can search for target electronic devices that are in the target location and the target range, from the electronic devices 370 currently maintaining sessions with the push server 300, with reference to the table. Since there are one or more connection management servers 320, operation of searching for target electronic devices can be distributively performed by the connection management servers 320. Accordingly, there can be no need for the service server 330 to search for target electronic devices, and unnecessary network traffic can be reduced.

Accordingly, since the individual connection management servers 320 can search for target electronic devices that are in the target location and the target range, a time taken to search for the target electronic devices can be minimized, and as a result, push messages can be quickly transmitted to the target electronic devices. As such, since operation of searching for target electronic devices that are in the target location and the target range is distributively processed by a plurality of connection management servers, other application services using a push service can be less influenced.

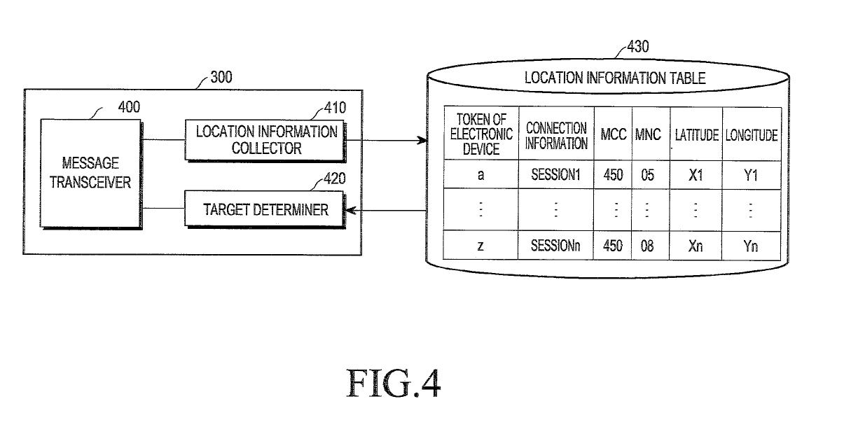

A configuration and operations of the push server 300 having the above-described function will be described with reference to FIG. 4, below. FIG. 4 is an example block diagram illustrating a configuration of the push server 300 according to this disclosure.

Referring to FIG. 4, the push server 300 can include a message transceiver 400, a location information collector 410, and a target determiner 420.

The message transceiver 400 can transmit a push message to an electronic device, and receive a response message from the electronic device. Also, the message transceiver 400 can receive a connection request message from the electronic device. Also, the message transceiver 400 can receive a push message transmission request including information about a target location to which the push message is to be broadcasted, from the service server 330 (see, for example, FIG. 3).

The location information collector 410 can acquire location information of the electronic device. The location information of the electronic device can include at least one among a token of the electronic device, information about a session connection with the push server 300, network identification information, and coordinates. The location information collector 410 can acquire network identification information through a base station of a wireless network in which the electronic device is located. The network identification information can include a Mobile Country Code (MCC) and a Mobile Network Code (MNC). The MNC is network provider information. For example, the MNC can be network operator information.

The location information collector 410 can map location information of a plurality of electronic devices maintaining sessions with the push server 300, to the corresponding electronic devices, and can store the results of the mapping in the form of a table. An example of such a table is a location information table 430 of FIG. 4. The location information table 430 can be stored in a volatile memory of the push server 400. If a session with at least one electronic device of the plurality of electronic devices maintaining sessions with the push server 300 is disconnected, the location information collector 410 can delete location information of the disconnected electronic device from the table.

The location information table 430 can be obtained by mapping at least one token among tokens of the plurality of electronic devices maintaining sessions with the push server 300, the tokens representing information about the locations of the electronic devices at the time when the electronic devices connect to the push server 300, information about sessions connected between the push server 300 and the electronic devices, a MCC(s), a MNC(s), latitudes, and longitudes, to the respective electronic devices.

The target determiner 420 can search for, if receiving push messages including a target location and a target range (X, Y, range) through the message transceiver 400, target electronic devices that are in the target location and the target range from among the plurality of electronic devices currently maintaining sessions with the push server 300, with reference to the table. Accordingly, the target determiner 420 can determine target electronic devices to which the push messages are to be transferred, and transfer the push messages to the determined target electronic devices. Since the target determiner 420 searches for target electronic devices from among the plurality of electronic devices maintaining sessions with the push server 300, the target determiner 420 can filter target electronic devices at high speed. Also, since operation of determining whether or not to transmit push messages to electronic devices maintaining sessions with the push server 300 is distributively processed, other services can be less influenced.

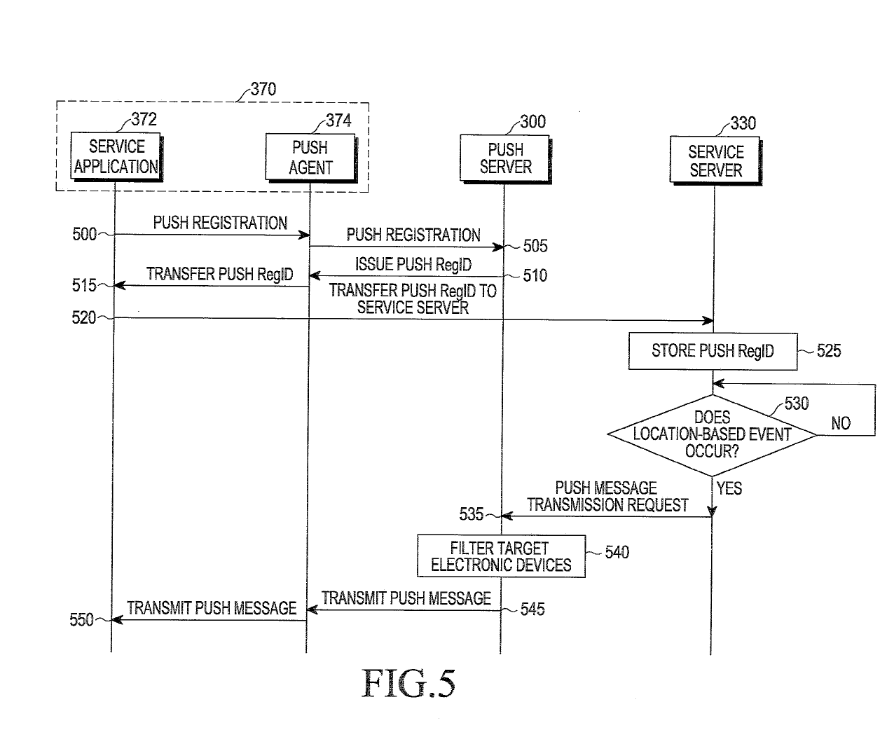

FIG. 5 is an example flowchart illustrating a method of controlling transmission of push messages according to this disclosure. In FIG. 5, a service application 372 can be an application installed in the electronic device 370 (see, for example, FIG. 3), and a push agent 374 can function to communicate with the push server 300.

In operations 500 and 505, the service application 372 can perform push registration in the push server 300 through the push agent 374 so that the electronic device 370 can receive a push service from the push server 300 when the service application 372 is installed in the electronic device 370. The push registration can be performed before the electronic device 370 first uses a push service. Upon the push registration of operation 505, location information of the electronic device 370 can be transferred to the push server 300. In an embodiment, when the electronic device 370 initially connects to the push server 300 in order to use a push service, when the electronic device 370 registers itself in the push server 300, when the electronic device 370 again enters a service area of the push server 300 after deviating out of the service area of the push server 300, or when the electronic device 370 again connects to the push server 300 after temporary disconnection from the push server 300, location information of the electronic device 370 can be transmitted to the push server 300.

In response to a push registration request from the electronic device 370, the push server 300 can authenticate the electronic device 370. The push server 300 can authenticate the electronic device 370, based on location information (for example, identification information) of the electronic device 370, included in the push registration request. The push server 300 can issue a push registration identifier (Push RegID) representing that a connection of the electronic device 370 to the push server 300 is allowed, in operation 510. The Push RegID can include at least one of application identification information and electronic device identification information. The Push RegID can be transferred to the service application 372 via the push agent 374, in operation 515. Then, the service application 372 can transmit the Push RegID to the service server 330, in operation 520. The service server 330 can be a server corresponding to the service application 372.

The service server 330 can store the Push RegID, in operation 525. Successively, the service server 330 can determine whether a location-based event occurs, in operation 530. If a location-based event occurs, for example, if a push message that needs to be sent to a predetermined area is generated, the service server 330 can request the push server 300 to transmit the push message, in operation 535. The push message transmission request can be a push message including a target location and a target range (X, Y, range) to which the push message is to be broadcasted. The push server 300 can receive such a push message transmission request from a service server corresponding to an application installed in at least one electronic device of a plurality of electronic devices.

The push server 300 can filter target electronic devices that are in the target location and the target range, with reference to a table that stores location information of a plurality of electronic devices maintaining sessions with the push server 300, in operation 540. Successively, in operation 545, the push server 300 can transmit push messages to one or more target electronic devices found by the filtering. The push agent 374 can receive the corresponding push message, and can transfer the push message to the service application 372, in operation 550. Accordingly, the location-based push message can be displayed on a screen of the target electronic device 370. For example, the service application 372 can output a push message for inducing a user to pay attention to a discount coupon, a gift, or event participation, based on real-time location.

In this way, the service server 330 can quickly send push messages to target electronic devices, without having to extract location information from subscriber information that is managed for each service and to create a list of targets to which push messages are to be sent whenever the service server 330 sends the push messages.

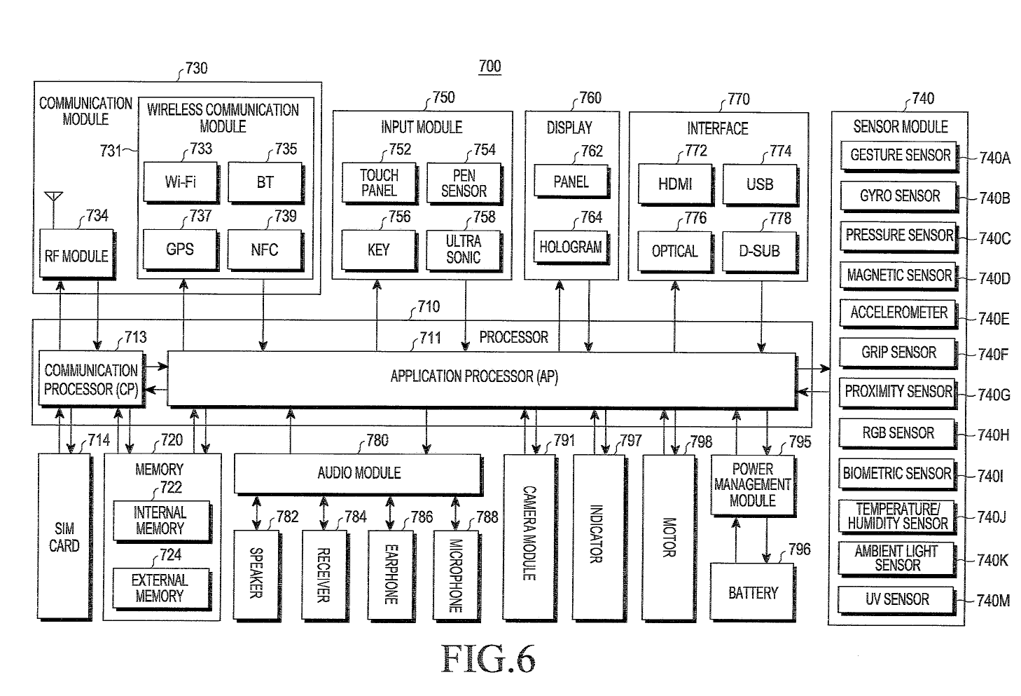

FIG. 6 is an example block diagram illustrating a configuration of hardware according to this disclosure.

Hardware 700 of FIG. 6 can be the electronic device 100 of FIG. 2. Referring to FIG. 6, the hardware 700 can include at least one processor 710, a Subscriber Identification Module (SIM) card 714, a memory 720, a communication module 730, a sensor module 740, a user input module 750, a display module 760, an interface 770, an audio codec 780, a camera module 791, a power management module 795, a battery 796, an indicator 797, and a motor 798.

The processor 710 (for example, the processor 120 of FIG. 2) can include at least one application processor (AP) 711 and at least one communication processor (CP) 713. In FIG. 6, the AP 711 and the CP 713 are shown to be included in the processor 710, however, the AP 711 and the CP 713 can be included in different IC packages, respectively. According to an embodiment, the AP 711 and the CP 713 can be included in the same IC package.

The AP 711 can execute Operating System (OS) or an application program to control a plurality of hardware or software components connected to the AP 711, and to process various data including multimedia data. The AP 711 can be System on Chip (SoC). According to an embodiment, the processor 710 can further include a Graphic Processing Unit (GPU) (not shown).

The CP 713 can function to manage a data link for communication between the electronic device (for example, the electronic device 100) including the hardware 700 and other electronic devices connected to the electronic device 100 through a network, and convert a communication protocol. The CP 713 can also be SoC. According to an embodiment, the CP 713 can be in charge of at least one part of multimedia control functions. The CP 713 can use, for example, a subscriber identification module (for example, a SIM card 714) to identify and authenticate an electronic device in a communication network. Also, the CP 713 can provide a user with services, such as voice call, video call, text message, or packet data.

In addition, the CP 713 can control data transmission/reception of the communication module 730. In FIG. 6, the CP 713, the power management module 795 or the memory 720 are separated from the AP 711, however, according to an embodiment, the AP 711 can include at least one part (for example, the CP 713) of the power management module 795, and the memory 720.

According to an embodiment, the AP 711 or the CP 713 can load a command or data received from at least one of a non-volatile memory or other components connected to the AP 711 or the CP 713, in a volatile memory, and process the command or data. Also, the AP 711 or the CP 713 can store data received from or created by at least one of other components, in a non-volatile memory.

The SIM card 714 can correspond to a subscriber identification module. The SIM card 714 can be inserted into a slot formed at a predetermined location of the electronic device. The SIM card 714 can include unique identification information (for example, Integrated Circuit Card Identifier (ICCID)) or subscriber information (for example, International Mobile Subscriber Identity (IMSI)).

The memory 720 can include an internal memory 722 and an external memory 724. The memory 720 can be the memory 130 of FIG. 2. The internal memory 722 can be a volatile memory (for example, Dynamic Random Access Memory (DRAM), Static RAM (SRAM), Synchronous Dynamic (SDRAM), or the like), or a non-volatile memory (for example, One Time Programmable Read Only Memory (OTPROM), Programmable ROM (PROM), Erasable and Programmable ROM (EPROM), Electrically Erasable and Programmable ROM (EEPROM), mask ROM, flash ROM, NAND flash memory, NOR flash memory, or the like). According to an embodiment, the internal memory 722 can be a Solid State Drive (SSD). The external memory 724 can further include a flash drive (for example, Compact Flash (CF), Secure Digital (SD), Micro Secure Digital (Micro-SD), Mini Secure Digital (Mini-SD), extreme Digital (xD), Memory Stick, or the like).

The communication module 730 can include a wireless communication module 731 and a Radio Frequency (RF) module 734. The communication module 730 can be the communication module 160 of FIG. 2. The wireless communication module 731 can include WiFi 733, BT 735, GPS 737, and NFC 739. For example, the wireless communication module 731 can provide a wireless communication function using a radio frequency. Additionally or alternatively, the wireless communication module 731 can include a network interface (for example, a LAN card) or a modem for connecting the hardware 700 to a network (for example, Internet, LAN, WAN, telecommunication network, cellular network, satellite network, POTS, or the like).

The RF module 734 can be in charge of transmission/reception of data, for example, transmission/reception of RF signals or called electronic signals. The RF module 734 can include, for example, a transceiver, a Power Amp Module (PAM), a frequency filter, and a Low Noise Amplifier (LNA). Also, the RF module 734 can further include an element (for example, a conductor or a conducting line) for transmitting/receiving electromagnetic waves on free space in wireless communication.

The sensor module 740 can include at least one among, for example, a gesture sensor 740A, a gyro sensor 740B, a pressure sensor 740C, a magnetic sensor 740D, an accelerometer 740E, a grip sensor 740F, a proximity sensor 740G, a RGB (Red, Green, Blue) sensor 740H, a biometric sensor 740I, a temperature/humidity sensor 740J, an ambient light sensor 740K, and an ultra violet (UV) sensor 740M. The sensor module 740 can sense physical quantity or the operating state of the electronic device, and convert the measured or sensed information into electrical signals. In addition, the sensor module 740 can include an E-nose sensor (not shown), an electromyography (EMG) sensor, an electroencephalogram (EEG) sensor, an electrocardiogram (ECG) sensor, and a fingerprint recognition sensor. The sensor module 740 can further include a control circuit to control at least one sensor included therein.

The user input module 750 can include a touch panel 752, a pen (digital pen) sensor 754, a key 756, and an ultrasonic input device 758. The user input module 750 can be the user input module 140 of FIG. 2. The touch panel 752 can be a capacitive type, a resistive type, an infrared type, or an ultrasonic type. Also, the touch panel 752 can further include a controller (not shown). If the touch panel 752 is a capacitive type, the touch panel 752 can recognize proximity as well as a direct touch input. The touch panel 752 can further include a tactile layer. In this case, the touch panel 752 can give a user tactile impression.

The pen sensor 754 can sense a pen touch input using a method that is the same as or similar to the method by which the touch panel 752 receives a touch input from a user. Also, the pen sensor 754 can sense a pen touch input using a recognition sheet. The key 756 can be a keypad or a touch key. The ultrasonic input device 758 is a device that can identify data by detecting a sound wave from the electronic device to a microphone (such as a microphone 788) through a pen generating an ultrasonic wave signal, and wireless recognition is possible therethrough. The ultrasonic input device 758 can enable RF identification (RFID). According to an embodiment, the hardware 700 can receive a user input from an external device (for example, a network, a computer, or a server) connected to the hardware 700, using the communication module 730.

The display module 760 can include a panel 762 and a hologram 764. The display module 760 can be the display module 150 of FIG. 2. The panel 762 can be a Liquid-Crystal Display (LCD) or an Active-Matrix Organic Light-Emitting Diode (AM-OLED). The panel 762 can be implemented to be flexible, transparent, or wearable. The panel 762 can be integrated into the touch panel 752. The hologram 764 can show a 3Dimensional (3D) image in the air using interference of light. According to an embodiment, the display module 760 can further include a control circuit for controlling the panel 762 or the hologram 764.

The interface 770 can include, for example, High-Definition Multimedia Interface (HDMI) 772, a Universal Serial Bus (UBS) 774, a projector 776, and a D-subminiature (D-sub) 778. Additionally or alternatively, the interface 770 can include, for example, a Secure Digital (SD)/Multi-Media Card (MMC), and an Infrared Data Association (IrDA) (not shown).

The audio codec 780 can convert voice into electronic signals and vice versa. The audio codec 780 can convert voice information input/output through, for example, a speaker 782, a receiver 784, earphones 786, or the microphone 788, into electrical signals or vice versa.

The camera module 791, which captures still images or moving images, can include one or more images sensors (for example, a front lens or a rear lens), an Image Signal Processor (ISP), and a flash LED.

The power management module 795 can manage power of the hardware 700. In an embodiment, the power management module 795 can include a Power Management Integrated Circuit (PMIC), a charge Integrated Circuit (IC), and a battery fuel gauge.

The PMIC can be installed in an integrated circuit or a SoC semiconductor. A charging method can be classified into a wired type and a wireless type. The charge IC can charge a battery, and prevent inflow of overvoltage or overcurrent from a charger. According to an embodiment, the charge IC can include a charge IC for at least one of a wired charging method and a wireless charging method. The wireless charging method can be a magnetic resonance method, a magnetic induction method, or an electromagnetic wave method, and in order to perform the wireless charging method, the charge IC can include additional circuits, for example, a coil loop, a resonance circuit, and a rectifier.

The battery gauge can measure, for example, a level of battery 796, and a voltage, a current, or a temperature during charging. The battery 796 can generate electricity to supply power. The battery 796 can be a rechargeable battery.

The indicator 797 can display a specific state (for example, a booting state, a message state, or battery level) of the hardware 700 or a part (for example, the AP 711) of the hardware 700. The motor 798 can convert electrical signals into mechanical vibration. The MCU 299 can control the sensor module 740.

In an embodiment, the hardware 700 can include a processor (for example, GPU) for supporting a mobile TV. The processor for supporting a mobile TV can process media data according to Digital Multimedia Broadcasting (DMB) standard, Digital Video Broadcasting (DVB) standard, or media flow standard.

Each of the above-described units of the hardware 700 according to the present disclosure can be configured with one or more components, and the units can be termed according to a kind of the corresponding electronic device. The hardware 700 can include at least one of the above-described units. Also, the hardware 700 can omit some of the above-described units or further include another one or more unit(s). Furthermore, some of the units of the hardware 700 can be combined to constitute entity which performs the same functions as the corresponding units.

The term “module” used in the present disclosure can means a unit including, for example, hardware, software, firmware, or a combination thereof. The “module” can be interchangeably used with another term, such as “unit”, “logic”, “logical block”, “component”, or “circuit”. The “module” can be a minimum unit or a part of components integrated into one body. Also, the “module” can be a minimum unit or a part for performing one or more functions. The “module” can be implemented mechanically or electronically. For example, the “module” can include at least one of an Application-Specific Integrated Circuit (ASIC) chip, Field-Programmable Gate Arrays (FPGAs), or a programmable-logic device, which performs certain operations, already developed or to be developed in future.

According to various embodiment of the present disclosure, by efficiently managing location information of a plurality of electronic devices, the operating efficiency of a location-based push service can increase.

Also, according to various embodiment of the present disclosure, by minimizing a time taken to search for a plurality of target electronic devices when a location-based push service is provided, push messages can be quickly transmitted to the plurality of target electronic devices.

Also, according to various embodiment of the present disclosure, by minimizing influence on other services, a large amount of push messages can be efficiently sent without exceeding an available transmission amount allocated to each service.

Although the present disclosure has been described with an exemplary embodiment, various changes and modifications can be suggested to one skilled in the art. It is intended that the present disclosure encompass such changes and modifications as fall within the scope of the appended claims.

What is claimed is:

1. A method of providing a location-based push service in a push server, comprising:
searching for at least one target electronic device to which a push message is to be transmitted, from among a plurality of electronic devices maintaining sessions with the push server, with reference to a table that stores location information of the plurality of electronic devices; and
transmitting the push message to at least one target electronic device that was found.

2. The method of claim 1, further comprising receiving a push message transmission request including information about a target location to which the push message is to be broadcasted.

3. The method of claim 2, wherein the searching of the at least one target electronic device comprises searching for at least one target electronic device corresponding to the information about the target location.

4. The method of claim 2, wherein the information about the target location to which the push message is to be broadcasted includes coordinates and a range of the target location to which the push message is to be broadcasted.

5. The method of claim 2, wherein the push message transmission request is received from a service server corresponding to an application installed in at least one electronic device among the plurality of electronic devices.

6. The method of claim 1, wherein location information of each of the plurality of electronic devices maintaining sessions with the push server includes at least one among a token of the corresponding electronic device, information about a session connection with the push server, network identification information, and location coordinates.

7. The method of claim 1, further comprising acquiring the location information of the plurality of electronic devices from the plurality of electronic devices, at the time when the respective electronic devices connect to the push server.

8. The method of claim 7, wherein the location information is transferred to the push server when at least one electronic device of the plurality of electronic devices initially connects to the push server, when the at least one electronic device registers itself in the push server, when the at least one electronic device again enters a service area of the push server after deviating out of the service area of the push server, or when the at least one electronic device again connects to the push server after temporary disconnection from the push server.

9. The method of claim 1, further comprising deleting, if a session with at least one electronic device of the plurality of electronic devices is disconnected from the push server, location information of the electronic device disconnected from the push server from the table.

10. A push server of providing a location-based push service, comprising:
a memory configured to store a table in which location information of a plurality of electronic devices maintaining sessions with the push server is mapped to the corresponding electronic devices;
a message transceiver configured to transmit a message; and
a target determiner configured to search for at least one target electronic device to which a push message is to be transmitted, from among the plurality of electronic devices, with reference to the table, and to control the message transceiver to transmit the push message to the found at least one target electronic device.

11. The push server of claim 10, wherein the message transceiver is configured to receive a push message transmission request including information about a target location to which the push message is to be broadcasted.

12. The push server of claim 11, wherein the target determiner is configured to search for at least one target electronic device corresponding to the information about the target location.

13. The push server of claim 11, wherein the information about the target location to which the push message is to be broadcasted includes coordinates and a range of the target location to which the push message is to be broadcasted.

14. The push server of claim 10, wherein the push message transmission request is received from a service server corresponding to an application installed in at least one electronic device among the plurality of electronic devices.

15. The push server of claim 10, wherein the location information of each of the plurality of electronic devices maintaining sessions with the push server includes at least one among a token of the corresponding electronic device, information about a session connection with the push server, network identification information, and location coordinates.

16. The push server of claim 10, further comprising a location information collector configured to acquire the location information of the plurality of electronic devices from the plurality of electronic devices at the time when the respective electronic devices connect to the push server.

17. The push server of claim 16, wherein the location information is transferred to the push server when at least one electronic device of the plurality of electronic devices initially connects to the push server, when the at least one electronic device registers itself in the push server, when the at least one electronic device again enters a service area of the push server after deviating out of the service area of the push server, or when the at least one electronic device again connects to the push server after temporary disconnection from the push server.

18. The push server of claim 16, wherein the location information collector is configured to delete, if a session with at least one electronic device of the plurality of electronic devices is disconnected, location information of the disconnected electronic device from the table.
